(19) United States
(12) Patent Application Publication
(10) Pub. No.: US 2023/0247478 A1
(43) Pub. Date: Aug. 3, 2023

(54) BUFFER STATUS REPORTING TABLES FOR EXTREMELY HIGH DATA RATE

(71) Applicant: Telefonaktiebolaget LM Ericsson (publ), Stockholm (SE)

(72) Inventors: Min Wang, Luleå (SE); Jan Christoffersson, Luleå (SE); Bikramjit Singh, Raasepori (FI); Stefan Wänstedt, Luleå (SE); Mårten Ericson, Gammelstad (SE)

(21) Appl. No.: 18/018,306

(22) PCT Filed: Jul. 28, 2021
(86) PCT No.: PCT/SE2021/050759

§ 371 Date: Jan. 27, 2023

Related U.S. Application Data
(60) Provisional application No. 63/059,448, filed on Jul. 31, 2020.

(51) Int. Cl. H04W 28/02

(52) U.S. Cl. CPC H04W 28/0278

(57) ABSTRACT

Systems and methods are disclosed herein for Buffer Status Reporting (BSR) in a cellular communications system. In one embodiment, a method performed by a wireless communication device for sending a BSR report in a cellular communications system comprises selecting, based on one or more parameters, one or more BSR tables to be used for a BSR report from among two or more available BSR tables. The method further comprises generating the BSR report using the one or more BSR tables and sending the BSR report to a base station.

### RELATED APPLICATIONS

This application claims the benefit of provisional patent application Ser. No. 63/059,448, filed Jul. 31, 2020, the disclosure of which is hereby incorporated herein by reference in its entirety.

### TECHNICAL FIELD

The present disclosure relates to cellular communications system and, more specifically, to Buffer Status Reporting (BSR).

### BACKGROUND

### NR Operation in Millimeter (Mm) Wave (Mm-Wave) Bands

Mobile broadband will continue to drive the demands for higher overall traffic capacity and higher achievable end-user data rates in the wireless access network. Several scenarios in the future will require data rates of up to 10 Gigabits per second (Gbps) in local areas. These demands for very high system capacity and very high end-user date rates can be met by networks with distances between access nodes ranging from a few meters in indoor deployments up to roughly 50 meters in outdoor deployments, i.e. with an infra-structure density considerably higher than the densest networks of today. The wide transmission bandwidths needed to provide data rates up to 10 Gbps and above can likely only be obtained from spectrum allocations in the mm-wave band. High-gain beamforming, typically realized with array antennas, can be used to mitigate the increased pathloss at higher frequencies. Such networks are referred to as New Radio (NR) systems in the following.

NR supports a diverse set of use cases and a diverse set of deployment scenarios. The latter includes deployment at both low frequencies (hundreds of Megahertz (MHz)), and very high frequencies (tens of Gigahertz (GHz)). Two operation frequency ranges are defined in NR Release 15: Frequency Range 1 (FR1) from 410 MHz to 7125 MHz and Frequency Range 2 (FR2) from 24.250 GHz to 52.6 GHz. The Third Generation Partnership Project (3GPP) Radio Access Network (RAN) is currently (NR Release 17) studying how to best support NR operation on FR2 frequencies, i.e. from 52.6 GHz to 71 GHz, as described in RP-193259, “3GPP Work Item Description: Study on supporting NR from 52.6 GHz to 71 GHz”, Intel Corporation, 3GPP TSG RAN Meeting #86, Dec. 9-12, 2019. This study item includes the following objectives:
Study of required changes to NR using existing downlink (DL)/uplink (UL) NR waveform to support operation between 52.6 GHz and 71 GHz.
   Study of applicable numerology including subcarrier spacing, channel bandwidth (BW) (including maximum BW), and their impact to FR2 physical layer design to support system functionality considering practical Radio Frequency (RF) impairments [RAN1, RAN4].
   Identify potential critical problems to physical signal/channels, if any [RAN1].
Study of channel access mechanism, considering potential interference to/from other nodes, assuming beam-based operation, in order to comply with the regulatory requirements applicable to unlicensed spectrum for frequencies between 52.6 GHz and 71 GHz [RAN1].
   Note: It is clarified that potential interference impact, if identified, may require interference mitigation solutions as part of channel access mechanism.

### NR Frame Structure

Similar to Long Term Evolution (LTE), NR uses Orthogonal Frequency Division Multiplexing (OFDM) in the downlink (i.e., from a network node, gNB, eNB, or base station, to a user equipment or UE). The basic NR physical resource over an antenna port can thus be seen as a time-frequency grid as illustrated in FIG. 1, where a resource block (RB) in a 14-symbol slot is shown. A resource block corresponds to twelve contiguous subcarriers in the frequency domain. Resource blocks are numbered in the frequency domain, starting with zero from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2\hat{ }μ) kilohertz (kHz) where μ∈(0,1,2,3,4). Δf=15 kHz is the basic (or reference) subcarrier spacing that is also used in LTE.

In the time domain, downlink and uplink transmissions in NR will be organized into equally-sized subframes of 1 millisecond (ms) each, similar to LTE. A subframe is further divided into multiple slots of equal duration. The slot length for subcarrier spacing Δf=(15×2\hat{ }μ) kHz is ½\hat{ }μ ms. There is only one slot per subframe for Δf=15 kHz, and a slot consists of fourteen OFDM symbols.

Downlink transmissions are dynamically scheduled, i.e., in each slot the gNB transmits downlink control information (DCI) about which UE data is to be transmitted to and which resource blocks in the current downlink slot the data is transmitted on. This control information is typically transmitted in the first one or two OFDM symbols in each slot in NR. The control information is carried on the Physical Control Channel (PDCCH) and data is carried on the Physical Downlink Shared Channel (PDSCH). A UE first detects and decodes PDCCH and, if a PDCCH is decoded successfully, the UE then decodes the corresponding PDSCH based on the downlink assignment provided by decoded control information in the PDCCH.

In addition to PDCCH and PDSCH, there are also other channels and reference signals transmitted in the downlink, including Synchronization Signal Block (SSB), Channel State Information Reference Signal (CSI-RS), etc.

Uplink data transmissions, carried on Physical Uplink Shared Channel (PUSCH), can also be dynamically scheduled by the gNB by transmitting a DCI. The DCI (which is transmitted in the DL region) always indicates a scheduling time offset so that the PUSCH is transmitted in a slot in the UL region.

### Buffer Status Reporting

Buffer Status Reporting (BSR) is described in the 3GPP TS 38.321 V16.0.0, Clause 5.4.5, which is reproduced below.

### *****Excerpt from 3GPP TS 38.321 V16.0.0*****

### 5.4.5 Buffer Status Reporting

The Buffer Status reporting (BSR) procedure is used to provide the serving gNB with information about UL data volume in the MAC entity. In the case of IAB, it is additionally used by an IAB-MT to provide its parent IAB-DU with the information about the amount of the data expected to arrive at the MT of the JAB node from its child node(s) and or UE(s) connected to it. This BSR is referred to as Pre-emptive BSR.

For BSR other than Pre-emptive BSR, RRC configures the following parameters to control the BSR:
periodicBSR-Timer;
rebcBSR-Timer;
logicalChannelSR-DelayTimerApplied;
logicalChannelSR-DelayTimer;
logicalChannelSR-Mask;
logicalChannelGroup.

Each logical channel may be allocated to an LCG using the logicalChannelGroup. The maximum number of LCGs is eight.

The MAC entity determines the amount of UL data available for a logical channel according to the data volume calculation procedure in TSs 38.322 [3] and 38.323 [4].

A BSR other than Pre-emptive BSR shall be triggered if any of the following events occur:
UL data, for a logical channel which belongs to an LCG, becomes available to the MAC entity; and either
   this UL data belongs to a logical channel with higher priority than the priority of any logical channel containing available UL data which belong to any LCG; or
   none of the logical channels which belong to an LCG contains any available UL data.
in which case the BSR is referred below to as ‘Regular BSR’;
UL resources are allocated and number of padding bits is equal to or larger than the size of the Buffer Status Report MAC CE plus its subheader, in which case the BSR is referred below to as ‘Padding BSR’;
retxBSR-Timer expires, and at least one of the logical channels which belong to an LCG contains UL data, in which case the BSR is referred below to as ‘Regular BSR’;
periodicBSR-Timer expires, in which case the BSR is referred below to as ‘Periodic BSR’.
NOTE 1: When Regular BSR triggering events occur for multiple logical channels simultaneously, each logical channel triggers one separate Regular BSR.

If configured, Pre-emptive BSR may be triggered for the specific case of an IAB-MT if any of the following events occur:
UL grant is provided to child IAB node or UE;
BSR is received from child IAB node or UE.

For Regular BSR, the MAC entity shall:

```
1>if the BSR is triggered for a logical channel for which
logicalChannelSR-DelayTimerApplied with value true is configured by
upper layers:
  2>start or restart the logicalChannelSR-DelayTimer.
1>else:
  2>if running, stop the logicalChannelSR-DelayTimer.
```

For Regular and Periodic BSR, the MAC entity shall:

```
1>if more than one LCG has data available for transmission when the
MAC PDU containing the BSR is to be built:
  2>report Long BSR for all LCGs which have data available for
  transmission.
1>else:
  2>report Short BSR.
```

For Padding BSR, the MAC entity shall:

```
1>if the number of padding bits is equal to or larger than the size of the
Short BSR plus its subheader but smaller than the size of the Long BSR
plus its subheader:
  2>if more than one LCG has data available for transmission when the
  BSR is to be built:
    3>if the number of padding bits is equal to the size of the Short BSR
    plus its subheader:
      4>report Short Truncated BSR of the LCG with the highest priority
      logical channel with data available for transmission.
    3>else:
      4>report Long Truncated BSR of the LCG(s) with the logical
      channels having data available for transmission following a
      decreasing order of the highest priority logical channel (with or
      without data available for transmission) in each of these LCG(s),
      and in case of equal priority, in increasing order of LCGID.
  2>else:
    3>report Short BSR.
1>else if the number of padding bits is equal to or larger than the size of
the Long BSR plus its subheader:
  2>report Long BSR for all LCGs which have data available for
  transmission.
```

For Pre-emptive BSR, the MAC entity shall:
1>report Pre-emptive BSR.

For BSR triggered by retxBSR-Timer expiry, the MAC entity considers that the logical channel that triggered the BSR is the highest priority logical channel that has data available for transmission at the time the BSR is triggered.

The MAC entity shall:

```
  1>if the Buffer Status reporting procedure determines that at least one
  BSR other than Pre-emptive BSR has been triggered and not cancelled:
    2>if UL-SCH resources are available for a new transmission and the
    UL-SCH resources can accommodate the BSR MAC CE plus its
    subheader as a result of logical channel prioritization:
      3>instruct the Multiplexing and Assembly procedure to generate
      the BSR MAC CE(s);
      3>start or restart periodicBSR-Timer except when all the generated
      BSRs are long or short Truncated BSRs;
      3>start or restart retxBSR-Timer.
    2>if a Regular BSR has been triggered and logicalChannelSR-
    DelayTimer is not running:
      3>if there is no UL-SCH resource available for a new
      transmission; or
      3>if the MAC entity is configured with configured uplink grant(s)
      and the Regular BSR was triggered for a logical channel for which
      logicalChannelSR-Mask is set to false, or
      3>if the UL-SCH resources available for a new transmission do not
      meet the LCP mapping restrictions (see clause 5.4.3.1) configured
      for the logical channel that triggered the BSR:
        4>trigger a Scheduling Request.
  1>if the Buffer Status reporting procedure determines that at least one
  Pre-emptive BSR has been triggered and not cancelled:
    2>if UL-SCH resources are available for a new transmission and the
    UL-SCH resources can accommodate the Pre-emptive BSR MAC CE
    plus its subheader as a result of logical channel prioritization:
      3>instruct the Multiplexing and Assembly procedure to generate
      the Pre-emptive BSR MAC CE.
    2>else:
      3>trigger a Scheduling Request.
  NOTE 2: UL-SCH resources are considered available if the MAC entity
  has an active configuration for either type of configured uplink grants,
  or if the MAC entity has received a dynamic uplink grant, or if both of
  these conditions are met. If the MAC entity has determined at a given
  point in time that UL-SCH resources are available, this need not imply
  that UL-SCH resources are available for use at that point in time.
For the case when Pre-emptive BSR is being sent, a MAC PDU may
contain one BSR MAC CE for Pre-emptive BSR, and one BSR MAC CE
for BSR other than Pre-emptive BSR. A MAC PDU not containing a BSR
MAC CE for Pre-emptive BSR shall contain at most one BSR MAC CE,
even when multiple events have triggered a BSR. The Regular BSR and
the Periodic BSR shall have precedence over the padding BSR.
The MAC entity shall restart retxBSR-Timer upon reception of a grant for
transmission of new data on any UL-SCH.
All triggered BSRs other than Pre-emptive BSR may be cancelled when
the UL grant(s) can accommodate all pending data available for
transmission but is not sufficient to additionally accommodate the BSR
MAC CE plus its subheader. All BSRs other than Pre-emptive BSR
triggered prior to MAC PDU assembly shall be cancelled when a MAC
PDU is transmitted, regardless of LBT failure indication from lower
layers, and this PDU includes a Long or Short BSR MAC CE which
contains buffer status up to (and including) the last event that triggered a
BSR prior to the MAC PDU assembly. A Pre-emptive BSR shall be
cancelled when a MAC PDU is transmitted and this PDU includes the
corresponding Pre-emptive BSR MAC CE.
  NOTE 3: MAC PDU assembly can happen at any point in time
  between uplink grant reception and actual transmission of the
  corresponding MAC PDU. BSR and SR can be triggered after the
  assembly of a MAC PDU which contains a BSR MAC CE, but before
  the transmission of this MAC PDU. In addition, BSR and SR can be
  triggered during MAC PDU assembly.
  NOTE 4: Pre-emptive BSR may be used for the case of dual-connected
  IAB node. It is up to network implementation to work out the
  associated MAC entity or entities, and the associated expected amount
  of data. For the case of dual-connected IAB node, there may be
  ambiguity in Pre-emptive BSR calculations and interpretation by the
  receiving nodes in case where BH RLC channels mapped to different
  egress Cell Groups are not mapped to different ingress LCGs.
  NOTE 5: If a HARQ process is configured with
  cg-RetransmissionTimer and if the BSR is already included in a MAC
  PDU for transmission by this HARQ process, but not yet transmitted
  by lower layers, it is up to UE implementation how to handle the BSR
  content.
```

### *****End Excerpt from 3GPP TS 38.321 V16.0.0*****

Buffer Status Report Medium Access Control (MAC) Control Elements (CEs)

Buffer status report MAC CEs are described in the 3GPP TS 38.321 V16.0.0, Clause 6.1.3.1, which is reproduced below.

### *****Excerpt from 3GPP TS 38.321 V16.0.0*****

6.1.3.1 Buffer Status Report MAC CEs

Buffer Status Report (BSR) MAC CEs consist of either:
Short BSR format (fixed size); or
Long BSR format (variable size); or
Short Truncated BSR format (fixed size);
Long Truncated BSR format (variable size); or
Pre-emptive BSR format (variable size).

The BSR formats are identified by MAC subheaders with LCIDs as specified in Table 6.2.1-2.

The fields in the BSR MAC CE are defined as follows:
LCG ID: The Logical Channel Group ID field identifies the group of logical channel(s) whose buffer status is being reported. The length of the field is 3 bits;
LCGᵢ: For the Long BSR format, this field indicates the presence of the Buffer Size field for the logical channel group i. The LCGᵢ field set to 1 indicates that the Buffer Size field for the logical channel group i is reported. The LCGᵢ field set to 0 indicates that the Buffer Size field for the logical channel group i is not reported. For the Long Truncated BSR format, this field indicates whether logical channel group i has data available. The LCGᵢ field set to 1 indicates that logical channel group i has data available. The LCGᵢ field set to 0 indicates that logical channel group i does not have data available;
Buffer Size: The Buffer Size field identifies the total amount of data available according to the data volume calculation procedure in TSs 38.322 [3] and 38.323 [4] across all logical channels of a logical channel group after the MAC PDU has been built (i.e. after the logical channel prioritization procedure, which may result the value of the Buffer Size field to zero). The amount of data is indicated in number of bytes. The size of the RLC and MAC headers are not considered in the buffer size computation. The length of this field for the Short BSR format and the Short Truncated BSR format is 5 bits. The length of this field for the Long BSR format and the Long Truncated BSR format is 8 bits. The values for the 5-bit and 8-bit Buffer Size fields are shown in Tables 6.1.3.1-1 and 6.1.3.1-2, respectively. For the Long BSR format and the Long Truncated BSR format, the Buffer Size fields are included in ascending order based on the LCGᵢ. For the Long Truncated BSR format the number of Buffer Size fields included is maximised, while not exceeding the number of padding bits. For the Pre-emptive BSR, the Buffer Size field identifies the total amount of the data expected to arrive at the IAB-MT of the node where the Pre-emptive BSR is triggered. Pre-emptive BSR is identical to the Long BSR format.
NOTE 1: For the Pre-emptive BSR, if configured, the LCGs to be reported, the expected data volume calculation, the exact time to report Pre-emptive BSR and the associated LCH are left to implementation.
NOTE 2: The mapping of LCGs between the ingress and egress links of an IAB node for purposes of determining expected change in occupancy of IAB-MT buffers (to be reported as Pre-emptive BSR) is left to implementation.
NOTE 3: The number of the Buffer Size fields in the Long BSR and Long Truncated BSR format can be zero.

### Reproduced Herein as FIG. 2

FIG. 6.1.3.1-1: Short BSR and Short Truncated BSR MAC CE

### Reproduced Herein as FIG. 3

FIG. 6.1.3.1-2: Long BSR, Long Truncated BSR, and Pre-emptive BSR MAC CE

TABLE 6.1.3.1-1
Buffer size levels (in bytes) for 5-bit Buffer Size field

| Index | BS value |
|---|---|
| 0 | 0 |
| 1 | ≤10 |
| 2 | ≤14 |
| 3 | ≤20 |
| 4 | ≤28 |
| 5 | ≤38 |
| 6 | ≤53 |
| 7 | ≤74 |
| 8 | ≤102 |
| 9 | ≤142 |
| 10 | ≤198 |
| 11 | ≤276 |
| 12 | ≤384 |
| 13 | ≤535 |
| 14 | ≤745 |
| 15 | ≤1038 |
| 16 | ≤1446 |
| 17 | ≤2014 |
| 18 | ≤2806 |
| 19 | ≤3909 |
| 20 | ≤5446 |
| 21 | ≤7587 |
| 22 | ≤10570 |
| 23 | ≤14726 |
| 24 | ≤20516 |
| 25 | ≤28581 |
| 26 | ≤39818 |
| 27 | ≤55474 |
| 28 | ≤77284 |
| 29 | ≤107669 |
| 30 | ≤150000 |
| 31 | >150000 |

TABLE 6.1.3.1-2
Buffer size levels (in bytes) for 8-bit Buffer Size field

| Index | BS value |
|---|---|
| 0 | 0 |
| 1 | ≤10 |
| 2 | ≤11 |
| 3 | ≤12 |
| 4 | ≤13 |
| 5 | ≤14 |
| 6 | ≤15 |
| 7 | ≤16 |
| 8 | ≤17 |
| 9 | ≤18 |
| 10 | ≤19 |
| 11 | ≤20 |
| 12 | ≤22 |
| 13 | ≤23 |
| 14 | ≤25 |
| 15 | ≤26 |
| 16 | ≤28 |
| 17 | ≤30 |
| 18 | ≤32 |
| 19 | ≤34 |
| 20 | ≤36 |
| 21 | ≤38 |
| 22 | ≤40 |
| 23 | ≤43 |
| 24 | ≤46 |
| 25 | ≤49 |
| 26 | ≤52 |
| 27 | ≤55 |
| 28 | ≤59 |
| 29 | ≤62 |
| 30 | ≤66 |
| 31 | ≤71 |
| 32 | ≤75 |
| 33 | ≤80 |
| 34 | ≤85 |
| 35 | ≤91 |
| 36 | ≤97 |
| 37 | ≤103 |
| 38 | ≤110 |
| 39 | ≤117 |
| 40 | ≤124 |
| 41 | ≤132 |
| 42 | ≤141 |
| 43 | ≤150 |
| 44 | ≤160 |
| 45 | ≤170 |
| 46 | ≤181 |
| 47 | ≤193 |
| 48 | ≤205 |
| 49 | ≤218 |
| 50 | ≤233 |
| 51 | ≤248 |
| 52 | ≤264 |
| 53 | ≤281 |
| 54 | ≤299 |
| 55 | ≤318 |
| 56 | ≤339 |
| 57 | ≤361 |
| 58 | ≤384 |
| 59 | ≤409 |
| 60 | ≤436 |
| 61 | ≤464 |
| 62 | ≤494 |
| 63 | ≤526 |
| 64 | ≤560 |
| 65 | ≤597 |
| 66 | ≤635 |
| 67 | ≤677 |
| 68 | ≤720 |
| 69 | ≤767 |
| 70 | ≤817 |
| 71 | ≤870 |
| 72 | ≤926 |
| 73 | ≤987 |
| 74 | ≤1051 |
| 75 | ≤1119 |
| 76 | ≤1191 |
| 77 | ≤1269 |
| 78 | ≤1351 |
| 79 | ≤1439 |
| 80 | ≤1532 |
| 81 | ≤1631 |
| 82 | ≤1737 |
| 83 | ≤1850 |
| 84 | ≤1970 |
| 85 | ≤2098 |
| 86 | ≤2234 |
| 87 | ≤2379 |
| 88 | ≤2533 |
| 89 | ≤2698 |
| 90 | ≤2873 |
| 91 | ≤3059 |
| 92 | ≤3258 |
| 93 | ≤3469 |
| 94 | ≤3694 |
| 95 | ≤3934 |
| 96 | ≤4189 |
| 97 | ≤4461 |
| 98 | ≤4751 |
| 99 | ≤5059 |
| 100 | ≤5387 |
| 101 | ≤5737 |
| 102 | ≤6109 |
| 103 | ≤6506 |
| 104 | ≤6928 |
| 105 | ≤7378 |
| 106 | ≤7857 |
| 107 | ≤8367 |
| 108 | ≤8910 |
| 109 | ≤9488 |
| 110 | ≤10104 |
| 111 | ≤10760 |
| 112 | ≤11458 |
| 113 | ≤12202 |
| 114 | ≤12994 |
| 115 | ≤13838 |
| 116 | ≤14736 |
| 117 | ≤15692 |
| 118 | ≤16711 |
| 119 | ≤17795 |
| 120 | ≤18951 |
| 121 | ≤20181 |
| 122 | ≤21491 |
| 123 | ≤22885 |
| 124 | ≤24371 |
| 125 | ≤25953 |
| 126 | ≤27638 |
| 127 | ≤29431 |
| 128 | ≤31342 |
| 129 | ≤33376 |
| 130 | ≤35543 |
| 131 | ≤37850 |
| 132 | ≤40307 |
| 133 | ≤42923 |
| 134 | ≤45709 |
| 135 | ≤48676 |
| 136 | ≤51836 |
| 137 | ≤55200 |
| 138 | ≤58784 |
| 139 | ≤62599 |
| 140 | ≤66663 |
| 141 | ≤70990 |
| 142 | ≤75598 |
| 143 | ≤80505 |
| 144 | ≤85730 |
| 145 | ≤91295 |
| 146 | ≤97221 |
| 147 | ≤103532 |
| 148 | ≤110252 |
| 149 | ≤117409 |
| 150 | ≤125030 |
| 151 | ≤133146 |
| 152 | ≤141789 |
| 153 | ≤150992 |
| 154 | ≤160793 |
| 155 | ≤171231 |
| 156 | ≤182345 |
| 157 | ≤194182 |
| 158 | ≤206786 |
| 159 | ≤220209 |
| 160 | ≤234503 |
| 161 | ≤249725 |
| 162 | ≤265935 |
| 163 | ≤283197 |
| 164 | ≤301579 |
| 165 | ≤321155 |
| 166 | ≤342002 |
| 167 | ≤364202 |
| 168 | ≤387842 |
| 169 | ≤413018 |
| 170 | ≤439827 |
| 171 | ≤468377 |
| 172 | ≤498780 |
| 173 | ≤531156 |
| 174 | ≤565634 |
| 175 | ≤602350 |
| 176 | ≤641449 |
| 177 | ≤683087 |
| 178 | ≤727427 |
| 179 | ≤774645 |
| 180 | ≤824928 |
| 181 | ≤878475 |
| 182 | ≤935498 |
| 183 | ≤996222 |
| 184 | ≤1060888 |
| 185 | ≤1129752 |
| 186 | ≤1203085 |
| 187 | ≤1281179 |
| 188 | ≤1364342 |
| 189 | ≤1452903 |
| 190 | ≤1547213 |
| 191 | ≤1647644 |
| 192 | ≤1754595 |
| 193 | ≤1868488 |
| 194 | ≤1989774 |
| 195 | ≤2118933 |
| 196 | ≤2256475 |
| 197 | ≤2402946 |
| 198 | ≤2558924 |
| 199 | ≤2725027 |
| 200 | ≤2901912 |
| 201 | ≤3090279 |
| 202 | ≤3290873 |
| 203 | ≤3504487 |
| 204 | ≤3731968 |
| 205 | ≤3974215 |
| 206 | ≤4232186 |
| 207 | ≤4506902 |
| 208 | ≤4799451 |
| 209 | ≤5110989 |
| 210 | ≤5442750 |
| 211 | ≤5796046 |
| 212 | ≤6172275 |
| 213 | ≤6572925 |
| 214 | ≤6999582 |
| 215 | ≤7453933 |
| 216 | ≤7937777 |
| 217 | ≤8453028 |
| 218 | ≤9001725 |
| 219 | ≤9586039 |
| 220 | ≤10208280 |
| 221 | ≤10870913 |
| 222 | ≤11576557 |
| 223 | ≤12328006 |
| 224 | ≤13128233 |
| 225 | ≤13980403 |
| 226 | ≤14887889 |
| 227 | ≤15854280 |
| 228 | ≤16883401 |
| 229 | ≤17979324 |
| 230 | ≤19146385 |
| 231 | ≤20389201 |
| 232 | ≤21712690 |
| 233 | ≤23122088 |
| 234 | ≤24622972 |
| 235 | ≤26221280 |
| 236 | ≤27923336 |
| 237 | ≤29735875 |
| 238 | ≤31666069 |
| 239 | ≤33721553 |
| 240 | ≤35910462 |
| 241 | ≤38241455 |
| 242 | ≤40723756 |
| 243 | ≤43367187 |
| 244 | ≤46182206 |
| 245 | ≤49179951 |
| 246 | ≤52372284 |
| 247 | ≤55771835 |
| 248 | ≤59392055 |
| 249 | ≤63247269 |
| 250 | ≤67352729 |
| 251 | ≤71724679 |
| 252 | ≤76380419 |
| 253 | ≤81338368 |
| 254 | >81338368 |
| 255 | Reserved |

### *****End Excerpt from 3GPP TS 38.321 V16.0.0*****

### BSR Table Design

In LTE, the buffer size (BS) value table was designed considering the below formula (1)

Bₖ=Bₘᵢₙ┌(1+p)^{k}┐ (1)

where p=(Bₘₐₓ/Bₘᵢₙ)^{1(N-1)}−1 which indicates the step size between two subsequent BS levels. Bₘₐₓ and Bₘᵢₙ are maximum and the minimum possible buffer sizes that a UE may report, and Nis the number of steps.

Bₘₐₓ=Maximum Transport Block Size×2RTT×Nₘᵢₘₒ×N_{carrier} (2)

where RTT is the round-trip time, Nₘᵢₘₒ is maximum number of MIMO layers, and N_{carrier} is maximum number of component carriers.

The maximum buffer size Bₘₐₓ is determined taking into account the maximum UL transport block size and a Hybrid Automatic Repeat Request (HARQ) acknowledge time of two HARQ Round Trip Times (RTTs) (i.e., 8 ms in case of 1 ms Transmit Time Interval (TTI)). The minimum buffer size Bₘᵢₙ is 10 bytes. For both tables, the number of buffer size levels is 2⁶=64. As another alternative, BSR report interval may be used to replace 2 HARQ RTTs in the formula (2). This alternative would be better, especially in case asynchronous HARQ is applied for PUSCH transmission.

NR has used the same formula (1) as in LTE. NR has designed two BSR tables. One table supports the BS field with the size of 5 bits (i.e., short BSR), while another table supports the BS field with the size of 8 bits. For the first table, Bₘₐₓ is set to 150000 bytes, while for the second table, Bₘₐₓ is set to 81338368 bytes.

### Short BSR

A short BSR report is useful when there is not enough room in the MAC layer to carry a regular BSR report or there is only one Logical Channel Group (LCG) that has data in LTE. Such BSR mechanism is still meaningful in LTE. Certain enhancements need to be considered for NR and future systems.

### SUMMARY

Systems and methods are disclosed herein for Buffer Status Reporting (BSR) in a cellular communications system. In one embodiment, a method performed by a wireless communication device for sending a BSR report in a cellular communications system comprises selecting, based on one or more parameters, one or more BSR tables to be used for a BSR report from among two or more available BSR tables. The one or more parameters comprise: (a) one or more services associated with one or more logical channels (LCHs) or logical channel groups (LCGs) for which one or more respective buffer size values are to be reported in the BSR report, (b) the one or more LCHs or LCGs for which one or more respective buffer size values are to be reported in the BSR report, (c) one or more numerologies used for the one or more LCHs or LCGs for which one or more respective buffer size values are to be reported in the BSR report, (d) one or more bitrates used for the one or more LCHs or LCGs for which one or more respective buffer size values are to be reported in the BSR report, (e) one or more buffer levels associated with the one or more LCHs or LCGs for which one or more respective buffer size values are to be reported in the BSR report, (f) one or more physical layer priorities associated with the one or more LCHs or LCGs for which one or more respective buffer size values are to be reported in the BSR report, (g) one or more capabilities of the wireless communication device, (h) a channel condition for a radio channel between the wireless communication device and the base station, (i) a system load of the cellular communications system, (j) a measured BSR mismatch, (k) one or more respective services, or (l) a combination of any two or more of (a)-(k). The method further comprises generating the BSR report using the one or more BSR tables and sending the BSR report to a base station. In this manner, the accuracy of the BSR report can be improved, e.g., by adapting which BSR table(s) are used to achieve a desired level of accuracy while also matching, e.g., radio capacity and transmission delay of the cellular communications system.

In one embodiment, the two or more available BSR tables comprise two or more BSR tables defined based on (A) a maximum uplink transport block size, (B) a maximum number of Multiple Input Multiple Output (MIMO) layers, (C) a maximum number of component carriers, (D) a maximum carrier bandwidth of each component carrier that the wireless communication device may support, (E) a longest Hybrid Automatic Repeat Request (HARQ) round-trip-time length, (F) a fraction of slots that are uplink slots in case of TDD, (G) a number of bits occupied by a buffer size field of the BSR report, or (H) a combination of any two or more of (A)-(G).

In one embodiment, selecting the one or more BSR tables comprises selecting, based on the one or more parameters, two or more BSR tables from among the two or more available BSR tables. In one embodiment, the two or more BSR tables are different BSR tables for two or more different LCHs or LCGs for which respective buffer size values are to be reported in the BSR report. In one embodiment, the two or more BSR tables are used to indicate buffer sizes for respective buffer size fields comprised in the BSR report. In one embodiment, a size of one of the buffer size fields is different than a size of another one of the buffer size fields.

In one embodiment, selecting the one or more BSR tables comprises selecting the one or more BSR tables to be used for the BSR report from among the two or more available BSR tables based on BSR table mappings, BSR table mappings comprising: (i) mappings between the two or more available BSR tables and two or more services, (ii) mappings between the two or more available BSR tables and two or more LCHs, (iii) mappings between the two or more available BSR tables and two or more LCGs, (iv) mappings between the two or more available BSR tables and two or more numerologies, (v) mappings between the two or more available BSR tables and two or more bitrates, (vi) mappings between the two or more available BSR tables and two or more buffer levels, (vii) mappings between the two or more available BSR tables and two or more physical layer priorities, or (viii) a combination of any two or more of (i)-(vii). In one embodiment, the method further comprises obtaining the BSR table mappings.

In one embodiment, the method further comprises obtaining information that defines the two or more available BSR tables. In one embodiment, the information that defines the two or more available BSR tables comprises information that defines, for each available BSR table from among the two or more available BSR tables, a plurality of buffer size values in the available BSR table. In one embodiment, the information that defines the two or more available BSR tables comprises information that defines, for each of at least one of the two or more available BSR tables, information that indicates a granularity of the available BSR table.

In one embodiment, selecting the one or more BSR tables comprises selecting the one or more BSR tables from among a set of BSR tables comprising the two or more available BSR tables and a default BSR table.

In one embodiment, the method further comprises sending, to the base station, one or more indications of the one or more BSR tables used for the BSR report, respectively.

Corresponding embodiments of a wireless communication device are also disclosed. In one embodiment, a wireless communication device for sending a BSR report in a cellular communications system is adapted to select, based on one or more parameters, one or more BSR tables to be used for a BSR report from among two or more available BSR tables. The one or more parameters comprise: (a) one or more services associated with one or more LCHs or LCGs for which one or more respective buffer size values are to be reported in the BSR report, (b) the one or more LCHs or LCGs for which one or more respective buffer size values are to be reported in the BSR report, (c) one or more numerologies used for the one or more LCHs or LCGs for which one or more respective buffer size values are to be reported in the BSR report, (d) one or more bitrates used for the one or more LCHs or LCGs for which one or more respective buffer size values are to be reported in the BSR report, (e) one or more buffer levels associated with the one or more LCHs or LCGs for which one or more respective buffer size values are to be reported in the BSR report, (f) one or more physical layer priorities associated with the one or more LCHs or LCGs for which one or more respective buffer size values are to be reported in the BSR report, (g) one or more capabilities of the wireless communication device, (h) a channel condition for a radio channel between the wireless communication device and the base station, (i) a system load of the cellular communications system, (j) a measured BSR mismatch, (k) one or more respective services, or (l) a combination of any two or more of (a)-(k). The wireless communication device is further adapted to generate the BSR report using the one or more BSR tables and send the BSR report to a base station.

In one embodiment, a wireless communication device for sending a BSR report in a cellular communications system comprises one or more transmitters, one or more receivers, and processing circuitry associated with the one or more transmitters and the one or more receivers. The processing circuitry is configured to cause the wireless communication device to select, based on one or more parameters, one or more BSR tables to be used for a BSR report from among two or more available BSR tables. The one or more parameters comprise: (a) one or more services associated with one or more LCHs or LCGs for which one or more respective buffer size values are to be reported in the BSR report, (b) the one or more LCHs or LCGs for which one or more respective buffer size values are to be reported in the BSR report, (c) one or more numerologies used for the one or more LCHs or LCGs for which one or more respective buffer size values are to be reported in the BSR report, (d) one or more bitrates used for the one or more LCHs or LCGs for which one or more respective buffer size values are to be reported in the BSR report, (e) one or more buffer levels associated with the one or more LCHs or LCGs for which one or more respective buffer size values are to be reported in the BSR report, (f) one or more physical layer priorities associated with the one or more LCHs or LCGs for which one or more respective buffer size values are to be reported in the BSR report, (g) one or more capabilities of the wireless communication device, (h) a channel condition for a radio channel between the wireless communication device and the base station, (i) a system load of the cellular communications system, (j) a measured BSR mismatch, (k) one or more respective services, or (l) a combination of any two or more of (a)-(k). The processing circuitry is further configured to cause the wireless communication device to generate the BSR report using the one or more BSR tables and send the BSR report to a base station.

Embodiments of a method performed by a base station for a cellular communications system are also disclosed. In one embodiment, a method performed by a base station for a cellular communications system comprises receiving a BSR report from a wireless communication device, the BSR report comprising one or more buffer size fields. The method further comprises interpreting the one or more buffer size fields comprised in the BSR report based on one or more respective BSR tables used for the one or more buffer size fields. The one or more BSR tables used for the one or more buffer size fields comprised in the BSR report are a function of one or more parameters, the one or more parameters comprising: (a) one or more services associated with one or more LCHs or LCGs for which one or more respective buffer size values are to be reported in the BSR report, (b) the one or more LCHs or LCGs for which one or more respective buffer size values are to be reported in the BSR report, (c) one or more numerologies used for the one or more LCHs or LCGs for which one or more respective buffer size values are to be reported in the BSR report, (d) one or more bitrates used for the one or more LCHs or LCGs for which one or more respective buffer size values are to be reported in the BSR report, (e) one or more buffer levels associated with the one or more LCHs or LCGs for which one or more respective buffer size values are to be reported in the BSR report, (f) one or more physical layer priorities associated with the one or more LCHs or LCGs for which one or more respective buffer size values are to be reported in the BSR report, (g) one or more capabilities of the wireless communication device, (h) a channel condition for a radio channel between the wireless communication device and the base station, (i) a system load of the cellular communications system, (j) a measured BSR mismatch, (k) one or more respective services, or (l) a combination of any two or more of (a)-(k).

In one embodiment, the one or more BSR tables are from among two or more available BSR tables, the two or more available BSR tables comprising two or more BSR tables defined based on (A) a maximum uplink transport block size, (B) a maximum number of Multiple Input Multiple Output (MIMO) layers, (C) a maximum number of component carriers, (D) a maximum carrier bandwidth of each component carrier that the wireless communication device may support, (E) a longest Hybrid Automatic Repeat Request (HARQ) round-trip-time length, (F) a fraction of slots that are uplink slots in case of TDD, (G) a number of bits occupied by a buffer size field of the BSR report, or (H) a combination of any two or more of (A)-(G).

In one embodiment, the one or more buffer size fields consist of two or more buffer size fields, and the one or more BSR tables consist of two or more BSR tables used for the two or more buffer size fields, respectively. In one embodiment, the two or more BSR tables are different BSR tables for two or more different LCHs or LCGs for which respective buffer size values are reported in the BSR report. In one embodiment, a size of one of the buffer size fields is different than a size of another one of the buffer size fields.

In one embodiment, the one or more BSR tables used for the one or more buffer size fields in the BSR report are a function of one or more BSR table mappings comprising: (i) mappings between the two or more available BSR tables and two or more services, (ii) mappings between the two or more available BSR tables and two or more LCHs, (iii) mappings between the two or more available BSR tables and two or more LCGs, (iv) mappings between the two or more available BSR tables and two or more numerologies, (v) mappings between the two or more available BSR tables and two or more bitrates, (vi) mappings between the two or more available BSR tables and two or more buffer levels, (vii) mappings between the two or more available BSR tables and two or more physical layer priorities, or (viii) a combination of any two or more of (i)-(vii). In one embodiment, the method further comprises providing the BSR table mappings to the wireless communication device.

In one embodiment, the method further comprises providing, to the wireless communication device, information that defines the two or more available BSR tables. In one embodiment, the information that defines the two or more available BSR tables comprises information that defines, for each available BSR table from among the two or more available BSR tables, a plurality of buffer size values in the available BSR table. In one embodiment, the information that defines the two or more available BSR tables comprises information that defines, for each of at least one of the two or more available BSR tables, information that indicates a granularity of the available BSR table.

In one embodiment, the method further comprises providing a default BSR table to the wireless communication device.

In one embodiment, the method further comprises receiving, from the wireless communication device, one or more indications of the one or more BSR tables used for the BSR report, respectively. In one embodiment, interpreting the BSR report comprises interpreting the one or more buffer size fields comprised in the BSR report based on the one or more respective BSR tables indicated by the wireless communication device.

Corresponding embodiments of a base station for a cellular communications system are also disclosed. In one embodiment, a base station for a cellular communications system is adapted to receive a BSR report from a wireless communication device, the BSR report comprising one or more buffer size fields. The base station is further adapted to interpret the one or more buffer size fields comprised in the BSR report based on one or more respective BSR tables used for the one or more buffer size fields. The one or more BSR tables used for the one or more buffer size fields comprised in the BSR report are a function of one or more parameters, the one or more parameters comprising: (a) one or more services associated with one or more LCHs or LCGs for which one or more respective buffer size values are to be reported in the BSR report, (b) the one or more LCHs or LCGs for which one or more respective buffer size values are to be reported in the BSR report, (c) one or more numerologies used for the one or more LCHs or LCGs for which one or more respective buffer size values are to be reported in the BSR report, (d) one or more bitrates used for the one or more LCHs or LCGs for which one or more respective buffer size values are to be reported in the BSR report, (e) one or more buffer levels associated with the one or more LCHs or LCGs for which one or more respective buffer size values are to be reported in the BSR report, (f) one or more physical layer priorities associated with the one or more LCHs or LCGs for which one or more respective buffer size values are to be reported in the BSR report, (g) one or more capabilities of the wireless communication device, (h) a channel condition for a radio channel between the wireless communication device and the base station, (i) a system load of the cellular communications system, (j) a measured BSR mismatch, (k) one or more respective services, or (l) a combination of any two or more of (a)-(k).

In one embodiment, a base station for a cellular communications system comprises processing circuitry configured to cause the base station to receive a BSR report from a wireless communication device, the BSR report comprising one or more buffer size fields. The processing circuitry is further configured to cause the base station to interpret the one or more buffer size fields comprised in the BSR report based on one or more respective BSR tables used for the one or more buffer size fields. The one or more BSR tables used for the one or more buffer size fields comprised in the BSR report are a function of one or more parameters, the one or more parameters comprising: (a) one or more services associated with one or more LCHs or LCGs for which one or more respective buffer size values are to be reported in the BSR report, (b) the one or more LCHs or LCGs for which one or more respective buffer size values are to be reported in the BSR report, (c) one or more numerologies used for the one or more LCHs or LCGs for which one or more respective buffer size values are to be reported in the BSR report, (d) one or more bitrates used for the one or more LCHs or LCGs for which one or more respective buffer size values are to be reported in the BSR report, (e) one or more buffer levels associated with the one or more LCHs or LCGs for which one or more respective buffer size values are to be reported in the BSR report, (f) one or more physical layer priorities associated with the one or more LCHs or LCGs for which one or more respective buffer size values are to be reported in the BSR report, (g) one or more capabilities of the wireless communication device, (h) a channel condition for a radio channel between the wireless communication device and the base station, (i) a system load of the cellular communications system, (j) a measured BSR mismatch, (k) one or more respective services, or (l) a combination of any two or more of (a)-(k).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the basic Third Generation Partnership Project (3GPP) New Radio (NR) physical resource over an antenna port, which can be seen as a time-frequency grid;

FIG. 2 is a reproduction of FIG. 6.1.3.1-1 of 3GPP Technical Specification (TS) 38.321 V16.0.0;

FIG. 3 is a reproduction of FIG. 6.1.3.1-2 of 3GPP TS 38.321 V16.0.0;

FIG. 4 illustrates one example of improvement in accuracy of Buffer Status Reporting (BSR) in accordance with one example embodiment of the present disclosure;

FIG. 5 illustrates one example of a cellular communications system in which embodiments of the present disclosure may be implemented;

FIGS. 6A and 6B illustrates the operation of a User Equipment (UE) and a base station in accordance with embodiments of the present disclosure;

FIGS. 7, 8, and 9 are schematic block diagrams of example embodiments of a network node; and

FIGS. 10 and 11 are schematic block diagrams of example embodiments of a wireless communication device.

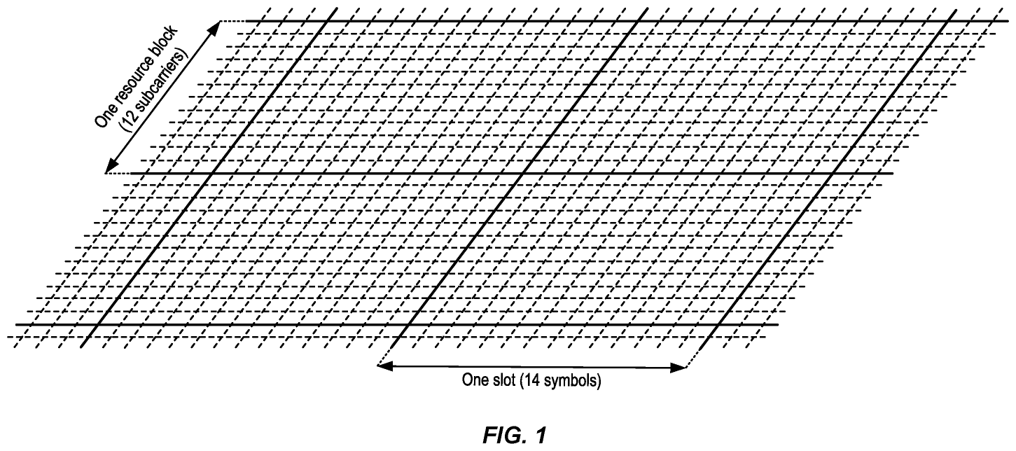

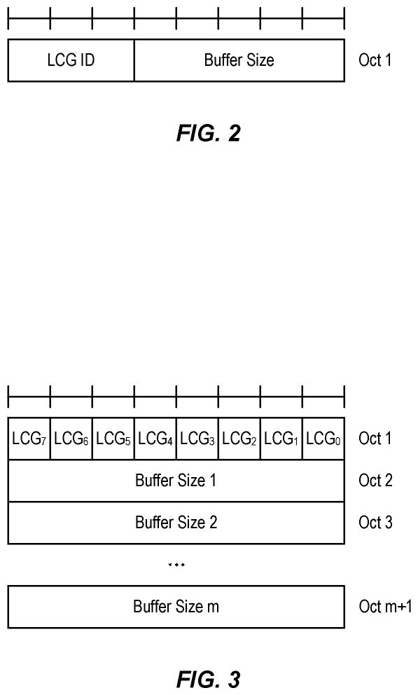

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s) with respect to Buffer Status Reporting (BSR), e.g., in a 3GPP network. The BSR value table is designed to reduce BSR overhead for a UE so that the UE reports buffer size (BS) according to the BSR value table instead of the actual value. Therefore, the size of the BS field is very important. A good balance between BSR overhead and BSR report accuracy needs to be carefully considered.

In NR, there are two different BSR value tables. One table supports the BS field with the size of 5 bits, while another table supports the BS field with the size of 8 bits. For the first table, Bₘₐₓ is set to 150000 bytes, while for the second table, Bₘₐₓ is set to 81338368 bytes. The first table was designed for short BSR, which is normally applied in case the UE has only one Logical Channel Group (LCG) with data available for transmission when the Medium Access Control (MAC) Protocol Data Unit (PDU) containing the BSR report is to be built. Otherwise, if the UE has more than one LCG with data available, the UE applies the second table.

Considering that a UE in future releases of NR may be configured with many different numerologies and Physical Uplink Shared Channel (PUSCH) durations, the Hybrid Automatic Repeat Request (HARQ) Round Trip Time (RU) time or BSR interval for each HARQ transmission may be different depending on the used numerology and PUSCH duration for that transmission. The different buffer size values can be reported by the UE for each BSR report cycle. Since the existing tables were mainly designed based on a subcarrier spacing of 15 kilohertz (kHz) and a PUSCH length of 1 millisecond (ms), this means that the existing NR BSR tables will be insufficient considering that the future UEs will support extremely high data rates.

As a summary, it is necessary to design new BSR tables for UEs supporting extremely high data rates.

Certain aspects of the present disclosure and their embodiments may provide solutions to the aforementioned or other challenges. Embodiments of the solution(s) described herein extend the legacy BSR framework to allow the use of a multitude of different BSR tables. In this way, the UE can apply one table for a Logical Channel (LCH)/Logical Channel Group (LCG) which is used for small data traffic and another table for an LCH/LCG with a higher traffic demand. The table that is to be used can be configured or depend on one or more factors such as, e.g., LCH/LCG, bit-rate, traffic type, load, channel conditions, etc., or any combination thereof.

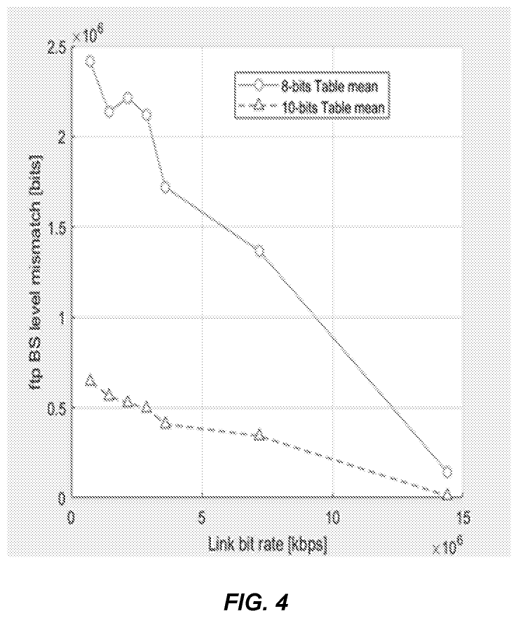

Certain embodiments may provide one or more of the following technical advantage(s). Embodiments of the solution(s) described herein may improve the accuracy of the BSR report by using the new tables. An example is shown in FIG. 4. This example illustrates the difference of BSR report accuracy between an 8-bit table and a 10-bit table. In such way, the BSR table can be adapted to achieve good granularity and meanwhile a good match to the radio capacity and the transmission delay of NR system.

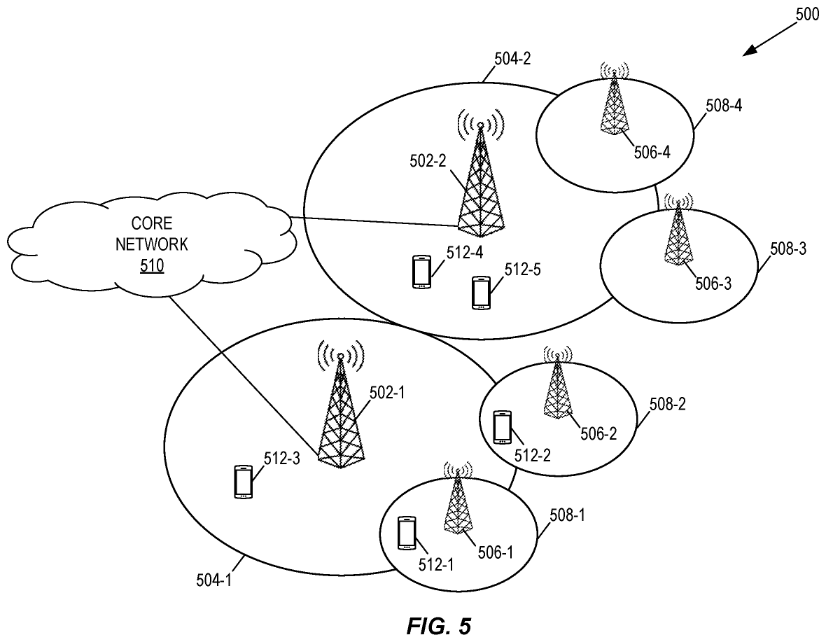

FIG. 5 illustrates one example of a cellular communications system 500 in which embodiments of the present disclosure may be implemented. In the embodiments described herein, the cellular communications system 500 is [a 5G system (5GS) including a Next Generation RAN (NG-RAN) and a 5G Core (5GC); however, the embodiments described herein may be utilized in any type of wireless communication system (e.g., any type of cellular communications system) in which BSR reports are utilized. In this example, the RAN includes base stations 502-1 and 502-2, which in the 5GS include NR base stations (gNBs) and optionally next generation eNBs (ng-eNBs) (e.g., LTE RAN nodes connected to the 5GC), controlling corresponding (macro) cells 504-1 and 504-2. The base stations 502-1 and 502-2 are generally referred to herein collectively as base stations 502 and individually as base station 502. Likewise, the (macro) cells 504-1 and 504-2 are generally referred to herein collectively as (macro) cells 504 and individually as (macro) cell 504. The RAN may also include a number of low power nodes 506-1 through 506-4 controlling corresponding small cells 508-1 through 508-4. The low power nodes 506-1 through 506-4 can be small base stations (such as pico or femto base stations) or Remote Radio Heads (RRHs), or the like. Notably, while not illustrated, one or more of the small cells 508-1 through 508-4 may alternatively be provided by the base stations 502. The low power nodes 506-1 through 506-4 are generally referred to herein collectively as low power nodes 506 and individually as low power node 506. Likewise, the small cells 508-1 through 508-4 are generally referred to herein collectively as small cells 508 and individually as small cell 508. The cellular communications system 500 also includes a core network 510, which in the 5G System (5GS) is referred to as the 5GC. The base stations 502 (and optionally the low power nodes 506) are connected to the core network 510.

The base stations 502 and the low power nodes 506 provide service to wireless communication devices 512-1 through 512-5 in the corresponding cells 504 and 508. The wireless communication devices 512-1 through 512-5 are generally referred to herein collectively as wireless communication devices 512 and individually as wireless communication device 512. In the following description, the wireless communication devices 512 are oftentimes UEs and as such sometimes referred to herein as UEs 512, but the present disclosure is not limited thereto.

In a first embodiment, a UE 512 is configured with one or multiple buffer size (BS) tables, which are also referred to herein as BSR tables or BSR value tables. The tables are defined considering at least one of the following factors: maximum uplink transport block size, maximum number of Multiple Input Multiple Output (MIMO) layers, maximum number of Component Carriers (CCs), maximum carrier bandwidth of each CC that the UE 512 may support, longest Hybrid Automatic Repeat Request (HARQ) Round Trip Time (RTT) length, a fraction of uplink (UL) slots in case of Time Division Duplexing (TDD) (i.e., a fraction of slots that are UL slots), and the number of bits that the BS field occupies. Different UEs may be configured with different BS tables. At least one of the below conditions may be considered for configuring the relation between BSR tables and services/LCHs/numerologies/bit rate values/buffer levels/PHY layer priorities:
Condition 1: a mapping relation between BSR tables and services is configured.
Condition 2: a mapping relation between BSR tables and LCHs is configured.
Condition 3: a mapping relation between BSR tables and LCGs is configured.
Condition 4: a mapping relation between BSR tables and numerologies (i.e., SCS, CP length or symbol duration) is configured.
Condition 5: a mapping relation between BSR tables and bit rate values is configured.
Condition 6: a mapping relation between BSR tables and buffer levels is configured.
Condition 7: a mapping relation between BSR table and PHY layer priority. Rules regarding how to map a BSR table to a UE/service/LCH/LCG/numerology/bit rate may be defined, e.g., in the 3GPP specification, e.g., in a hard-coded fashion.

According to a mapping relation or a hard rule, the UE 512 selects the appropriate BSR table for an LCH when preparing a BSR report.

In addition, in case each LCH/LCG applies a different BSR table, the size of the BS field corresponding to each LCH/LCG in the BSR report will be also different. In this case, each BS field in the BSR report may have different size depending on which table is configured for the associated LCH/LCG.

As an example of the first embodiment, a UE 512 can be configured with BSR table 1 for LCH/LCG 1, which is intended for small data traffic. This table can be designed with a high granularity for low BS (e.g., BS<200 bytes) and a lower granularity at higher BS levels. The UE 512 is also configured with BSR table 2 for LCH/LCG 2 which is intended for high data rate traffic. This table can be designed with a low granularity at low BS levels and high granularity at higher BS levels, compared to BSR table 1. Hereby the granularity will be high for both LCH/LCGs in the regions where the typical traffic loads will be. Also, the BS using table 1 may be reported with a shorter size for the BS field in the BSR report than the BS field using BSR table 2. Thus, the overhead (OH) of the BSR report transmissions is low.

In a second embodiment, the mapping relation of BSR tables may be configured to the UE 512 via signaling means such as system information, higher-layer signaling (e.g., Radio Resource Control (RRC) signaling) or dynamic signaling (e.g., Medium Access Control (MAC) Control Element (CE) or DCI).

In a third embodiment, a default BSR table may be configured to the UE 512. The UE 512 applies the default BSR table for an LCH or LCG in case there is no mapping relation or rule configured (e.g., yet) for that LCH or LCG when the UE 512 has data available for that LCH or LCG.

In a fourth embodiment, how to choose which BSR table for a UE 512 may be determined based on UE capability. In this case, it may be the set of available BSR tables for a specific UE capability and the specific mapping for a UE capability.

In a fifth embodiment, the UE 512 may choose different BSR tables depending on channel condition and/or system load. In case the channel is good (e.g., strong radio channel connection such as, e.g., RSRP above a configured or defined threshold) or the system load is low (e.g., below a configured or defined load threshold), the UE 512 applies a table of longer size, which can give more accurate BSR reports. In case the channel is bad (e.g., weak radio channel connection such as, e.g., RSRP below a configured or defined threshold) or system load is high (e.g., above a configured or defined load threshold), the UE 512 applies a table of short size, which can give less accurate BSR report which is beneficial to reduce the BSR overhead.

In a sixth embodiment, the UE 512 may choose a BSR table considering a measured BSR report mismatch, i.e., mismatch between the actual buffer size and the reported buffer size. BSR mismatch can be measured by either the UE 512 or a network node (e.g., the base station 502, e.g., the gNB). The measurements may be performed using at least one of the following means:
1) measured based on differences between received/sent grants and the sent/received data volume during a configured time period,
2) measured based on other indicators such as, e.g., retransmission ratio, packet delay, or packet loss, or accumulated queuing delay. In an example, especially when the buffer size is underestimated by the base station 502, the base station 502 would assign a smaller grant than the actual buffer size, which would cause the queuing delay to increase for the UE 502.

A BSR mismatch is caused either by too low BSR table granularity in some region of BS (e.g., for low BS) or by too low maximum BS value or high system load causing the base station 502 to not be able to give grants matching the BS value.

The UE 512 may perform measurements of BSR mismatch and send a measurement report to the network node. The network can then determine if the mismatch is caused by non-optimal BSR table (and configure a better one) or by high system load.

The network node (e.g., base station 502, e.g., gNB) may perform measurements of BSR mismatch for the UE 512 and send measurement results to the UE 512.

Alternatively, the measurement result could simply contain just one or multiple bits indicating one of the below pieces of information:

1) a BSR report mismatch may occur,

2) how large the BSR report mismatch would be.

In one embodiment, the BSR mismatch information is used by the UE 512 or the network node to select the BSR table.

In a seventh embodiment, when the BSR table is selected by the UE 512, the UE 512 may indicate its used BSR table (e.g., table index) to the network node (e.g., the base station 502) when reporting a BSR report. The indication may be carried in, e.g., a MAC CE or an RRC message. Alternatively, the applied BSR table may be indicated in an Uplink Control Information (UCI) (e.g., on PUCCH or PUSCH) or be indicated in the BSR report.

Extending further, the UE 512 can report multiple indices for reporting its multiple and different traffic needs at the same time (these different traffic/services can be identified as per the first embodiment), e.g., one index may correspond to certain table with low SCS, and other table's index may correspond to high SCS based traffic. Alternatively, this BSR reporting can be done via UCI.

In another embodiment, the different available BSR tables may be hard coded in the specification, e.g. TS 38.321 or conveyed via system information. Another option is to send BSR tables to a UE using dedicated RRC signaling. The latter option gives a large flexibility to design BSR tables to individual UEs.

In one embodiment, the granularity of a BSR table can be configured, e.g., in RRC. UE usually reports indices of the BSR table which maps to the window of buffer size. This buffer size window (or granularity) can be increased or decreased. Decreasing the size of the window will point to more accurate resource allocation and increasing the window size will help to accommodate a broader range of buffer sizes.

In one embodiment, a BSR table may be configured by the base station 502 (e.g., gNB) via signaling means such as system information, dedicated RRC signaling, MAC CE, or DCI. This would give greatest flexibility.

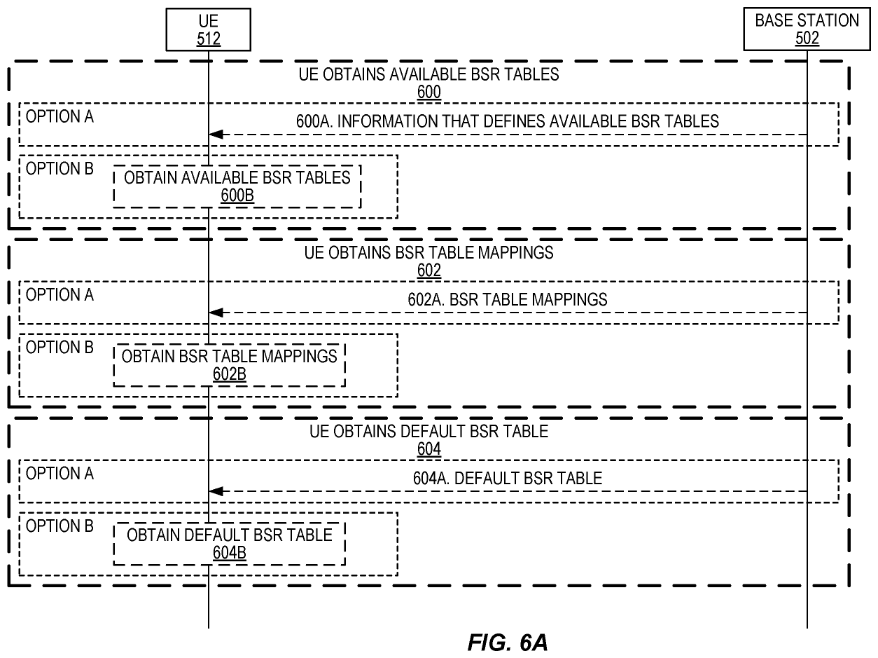

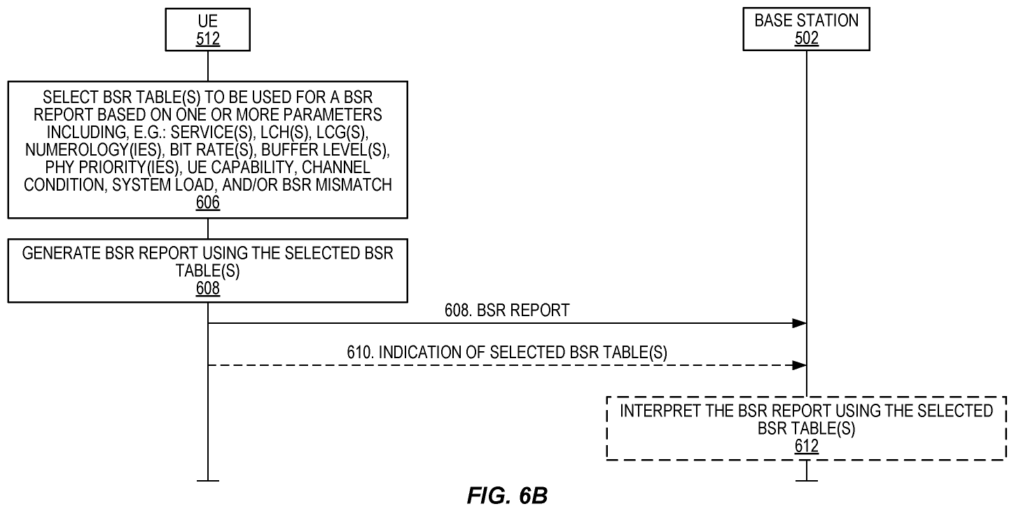

FIGS. 6A and 6B illustrates the operation of the UE 512 and base station 502 in accordance with at least some aspects of the embodiments described above. Optional steps are represented by dashed lines/boxes. As illustrated, the UE 512 obtains one or more available BSR tables (step 600). Preferably, in the illustrated embodiments, there are two or more available BSR tables. As such, the remainder of the description of FIGS. 6A and 6B assumes two or more available BSR tables unless explicitly stated otherwise. In one embodiment, the available BSR tables are defined considering maximum uplink transport block size, maximum number of MIMO layers, maximum number of component carriers, maximum carrier bandwidth of each component carrier that the UE 512 may support, a longest HARQ RTT length, a fraction of UL slots in case of TDD, and/or number of bits in the BS field of the BSR report.

The UE 512 may obtain the available BSR tables in any desired manner. For example, in some embodiments (referred to as “Option A”), the UE 512 receives information that defines the available BSR tables from a network node, which in the illustrated example is the base station 502 (step 600A). The information that defines the available BSR tables may include the BSR values for all entries in each of the available BSR tables, for example. In some other embodiments, for at least one of the available BSR tables, the information that defines the available BSR table includes information that indicates a granularity, or step-size, for the BSR table and, optionally, a minimum or maximum BS value for the available BSR table and optionally information that indicates the number of entries in the available BSR table (e.g., a number of bits used to index the BSR table). The information that defines the available BSR tables may be signaled to the UE 512 using any desired signaling mechanism such as, e.g., system information or dedicated signaling (e.g., RRC signaling, MAC CE, or DCI).

In some other embodiments (referred to as “Option B”), the UE 512 obtains the available BSR tables locally, e.g., from memory (step 600B). The available BSR tables may alternatively be hard-coded into the UE 512 and, e.g., defined by 3GPP specifications.

The UE 512 may also obtain information that defines mappings (i.e., relations) between the available BSR tables and one or more parameters such as, e.g., mappings between the available BSR tables and respective services, mappings between the available BSR tables and respective LCHs, mappings between the available BSR tables and respective LCGs, mappings between the available BSR tables and respective numerologies, mappings between the available BSR tables and respective bit rate values, mappings between the available BSR tables and respective buffer levels, and/or mappings between the available BSR tables and respective PHY layer priorities. In one embodiment (referred to as “Option A”), the information that defines the mappings is signaled to the UE 512 from a network node, which in the illustrated example is the base station 502 (step 602A). For example, this information may be signaled to the UE 512 via system information, RRC signaling, MAC CE, or DCI. In another embodiment (referred to as “Option B”), the UE 512 obtains the formation that defines the mappings locally, e.g., from memory (step 602B). The mappings may alternatively be hard-coded into the UE 512 and, e.g., defined by 3GPP specifications.

The UE 512 may also obtain a default BSR table (step 604). The default BSR table may be configured via signaling from a network node, which in the illustrated example is the base station 502 (step 604A). Alternatively, the UE 512 obtains the default BSR table locally, e.g., from memory (step 604B). The default BSR table may alternatively be hard-coded into the UE 512 and, e.g., defined by 3GPP specifications.

The UE 512 selects one or more BSR tables from among the available BSR tables (and optionally a default BSR table) to be used for a BSR report based on one or more parameters (step 606). The parameter(s) used by the UE 512 to select the one or more BSR tables include respective service(s), LCH(s), LCG(s), numerology(ies), bit rate(s), buffer level(s), PHY priority(ies), UE capability, channel condition, system load, and/or measured BSR mismatch(es), as described above. More specifically, the BSR report includes one or more BS fields for one or more LCH(s) or LCG(s), respectively. Thus, for each LCH or LCG for which a BS value is to be reported in the BSR report, the UE 512 selects a BSR table to be used indicate the appropriate BS value based on the service(s) being supported by the LCH/LCG, the LCH/LCG, the numerology used for the LCH/LCG, a bit rate used for the LCH/LCG, the buffer level for the LCH/LCG, a PHY priority for the LCH/LCG, the UE capability of the UE 512, the channel condition, the system load, and/or measured BSR mismatch, as described above. Thus, different BSR tables may be selected for different LCHs/LCGs.

The UE 512 generates the BSR report using the selected BSR table(s) and sends the BSR report to the base station 502 (step 608). The UE 512 may also send an indication(s) to the base station 502 that indicate the BSR table(s) used for the BSR report (step 610).

The base station 502 interprets the BSR report, and in particular the buffer size fields comprised in the BSR report, based on the respective BSR tables (step 612). The base station 502 may determine the BSR tables in a manner similar to that in which the UE 512 selected the BSR tables or based on the indications received from the UE 512 in step 610.

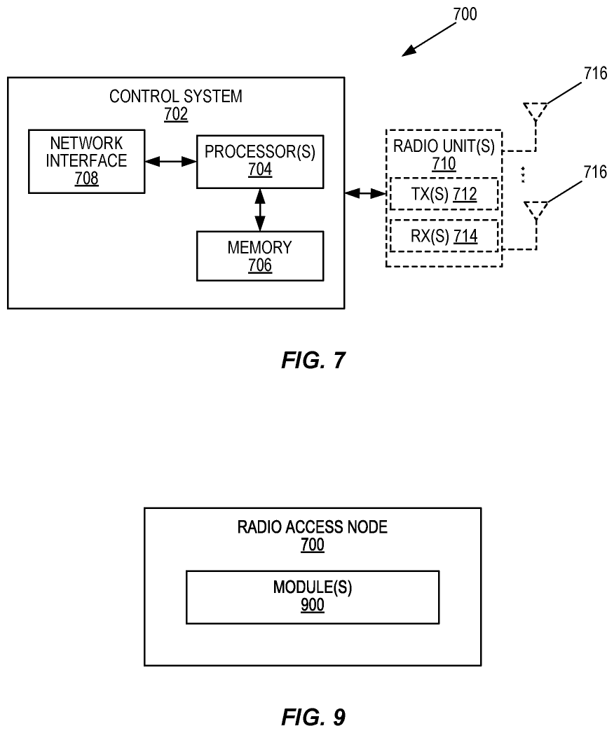

FIG. 7 is a schematic block diagram of a radio access node 700 according to some embodiments of the present disclosure. Optional features are represented by dashed boxes. The radio access node 700 may be, for example, a base station 502 or 506 or a network node that implements all or part of the functionality of the base station 502 or gNB described herein. As illustrated, the radio access node 700 includes a control system 702 that includes one or more processors 704 (e.g., Central Processing Units (CPUs), Application Specific Integrated Circuits (ASICs), Field Programmable Gate Arrays (FPGAs), and/or the like), memory 706, and a network interface 708. The one or more processors 704 are also referred to herein as processing circuitry. In addition, the radio access node 700 may include one or more radio units 710 that each includes one or more transmitters 712 and one or more receivers 714 coupled to one or more antennas 716. The radio units 710 may be referred to or be part of radio interface circuitry. In some embodiments, the radio unit(s) 710 is external to the control system 702 and connected to the control system 702 via, e.g., a wired connection (e.g., an optical cable). However, in some other embodiments, the radio unit(s) 710 and potentially the antenna(s) 716 are integrated together with the control system 702. The one or more processors 704 operate to provide one or more functions of the radio access node 700 as described herein (e.g., one or more functions of the base station 502 or gNB described herein). In some embodiments, the function(s) are implemented in software that is stored, e.g., in the memory 706 and executed by the one or more processors 704.

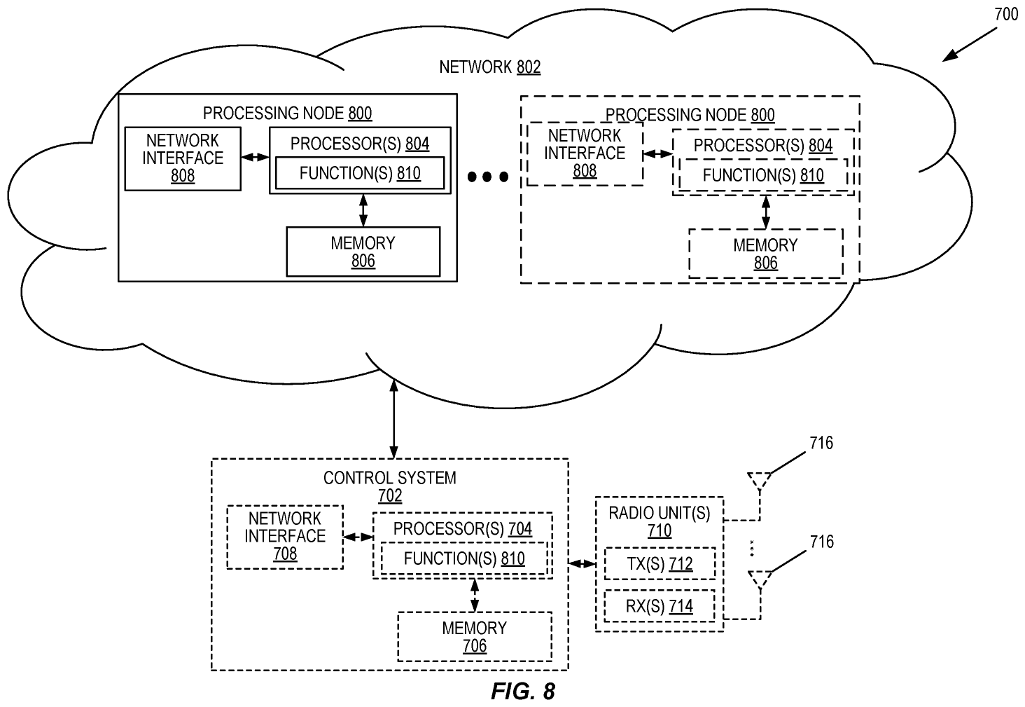

FIG. 8 is a schematic block diagram that illustrates a virtualized embodiment of the radio access node 700 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 700 in which at least a portion of the functionality of the radio access node 700 is implemented as a virtual component(s) (e.g., via a virtual machine(s) executing on a physical processing node(s) in a network(s)). As illustrated, in this example, the radio access node 700 may include the control system 702 and/or the one or more radio units 710, as described above. The control system 702 may be connected to the radio unit(s) 710 via, for example, an optical cable or the like. The radio access node 700 includes one or more processing nodes 800 coupled to or included as part of a network(s) 802. If present, the control system 702 or the radio unit(s) are connected to the processing node(s) 800 via the network 802. Each processing node 800 includes one or more processors 804 (e.g., CPUs, ASICs, FPGAs, and/or the like), memory 806, and a network interface 808.

In this example, functions 810 of the radio access node 700 described herein (e.g., one or more functions of the base station 502 or gNB described herein) are implemented at the one or more processing nodes 800 or distributed across the one or more processing nodes 800 and the control system 702 and/or the radio unit(s) 710 in any desired manner. In some particular embodiments, some or all of the functions 810 of the radio access node 700 described herein are implemented as virtual components executed by one or more virtual machines implemented in a virtual environment(s) hosted by the processing node(s) 800. As will be appreciated by one of ordinary skill in the art, additional signaling or communication between the processing node(s) 800 and the control system 702 is used in order to carry out at least some of the desired functions 810. Notably, in some embodiments, the control system 702 may not be included, in which case the radio unit(s) 710 communicate directly with the processing node(s) 800 via an appropriate network interface(s).

In some embodiments, a computer program including instructions which, when executed by at least one processor, causes the at least one processor to carry out the functionality of radio access node 700 or a node (e.g., a processing node 800) implementing one or more of the functions 810 of the radio access node 700 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the radio access node 700 according to some other embodiments of the present disclosure. The radio access node 700 includes one or more modules 900, each of which is implemented in software. The module(s) 900 provide the functionality of the radio access node 700 described herein (e.g., one or more functions of the base station 502 or gNB described herein). This discussion is equally applicable to the processing node 800 of FIG. 8 where the modules 900 may be implemented at one of the processing nodes 800 or distributed across multiple processing nodes 800 and/or distributed across the processing node(s) 800 and the control system 702.

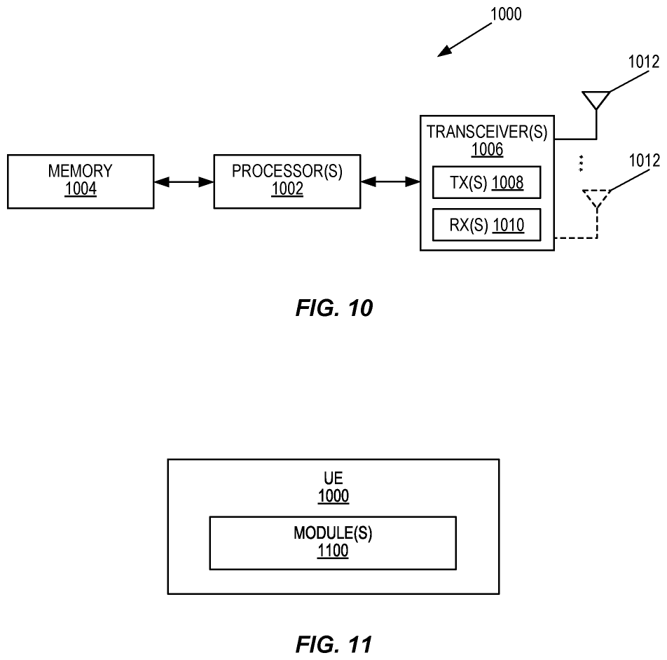

FIG. 10 is a schematic block diagram of a wireless communication device 1000 according to some embodiments of the present disclosure. The wireless communication device 1000 may be the wireless communication device 512, UE 512, or UE, as described herein. As illustrated, the wireless communication device 1000 includes one or more processors 1002 (e.g., CPUs, ASICs, FPGAs, and/or the like), memory 1004, and one or more transceivers 1006 each including one or more transmitters 1008 and one or more receivers 1010 coupled to one or more antennas 1012. The transceiver(s) 1006 includes radio-front end circuitry connected to the antenna(s) 1012 that is configured to condition signals communicated between the antenna(s) 1012 and the processor(s) 1002, as will be appreciated by on of ordinary skill in the art. The processors 1002 are also referred to herein as processing circuitry. The transceivers 1006 are also referred to herein as radio circuitry. In some embodiments, the functionality of the wireless communication device 1000 described above (e.g., one or more functions of the wireless communication device 512, UE 512, or UE described herein) may be fully or partially implemented in software that is, e.g., stored in the memory 1004 and executed by the processor(s) 1002. Note that the wireless communication device 1000 may include additional components not illustrated in FIG. 10 such as, e.g., one or more user interface components (e.g., an input/output interface including a display, buttons, a touch screen, a microphone, a speaker(s), and/or the like and/or any other components for allowing input of information into the wireless communication device 1000 and/or allowing output of information from the wireless communication device 1000), a power supply (e.g., a battery and associated power circuitry), etc.

In some embodiments, a computer program including instructions which, when executed by at least one processor, causes the at least one processor to carry out the functionality of the wireless communication device 1000 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the wireless communication device 1000 according to some other embodiments of the present disclosure. The wireless communication device 1000 includes one or more modules 1100, each of which is implemented in software. The module(s) 1100 provide the functionality of the wireless communication device 1000 described herein (e.g., one or more functions of the wireless communication device 512, UE 512, or UE described herein).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless communication device (512) for sending a buffer status reporting, BSR, report in a cellular communications system (500), the method comprising: selecting (604), based on one or more parameters, one or more BSR tables to be used for a BSR report from among two or more available BSR tables; generating (606) the BSR report using the one or more BSR tables; and sending (608) the BSR report to a base station (502).

Embodiment 2: The method of embodiment 1 wherein the two or more available BSR tables comprise two or more BSR tables defined based on a maximum uplink transport block size, a maximum number of MIMO layers, a maximum number of component carriers, a maximum carrier bandwidth of each component carrier that the wireless communication device (512) may support, a longest HARQ round-trip-time length, a fraction of slots that are uplink slots in case of TDD, and/or a number of bits occupied by a buffer size field of the BSR report.

Embodiment 3: The method of embodiment 1 or 2 wherein the one or more parameters comprise: (a) one or more services associated with one or more logical channels, LCHs, or logical channel groups, LCGs, for which one or more respective buffer size values are to be reported in the BSR report, (b) the one or more LCHs or LCGs for which one or more respective buffer size values are to be reported in the BSR report, (c) one or more numerologies used for the one or more LCHs or LCGs for which one or more respective buffer size values are to be reported in the BSR report, (d) one or more bitrates used for the one or more LCHs or LCGs for which one or more respective buffer size values are to be reported in the BSR report, (e) one or more buffer levels associated with the one or more LCHs or LCGs for which one or more respective buffer size values are to be reported in the BSR report, (f) one or more physical layer priorities associated with the one or more LCHs or LCGs for which one or more respective buffer size values are to be reported in the BSR report, (g) one or more capabilities of the wireless communication device (512), (h) a channel condition for a radio channel between the wireless communication device (512) and the base station (502), (i) a system load of the cellular communications system (500), (j) a measured BSR mismatch, or (k) a combination of any two or more of (a)-(j);

Embodiment 4: The method of any of embodiments 1 to 3 wherein selecting (606) the one or more BSR tables comprises selecting (606), based on the one or more parameters, two or more BSR tables from among the two or more available BSR tables.

Embodiment 5: The method of embodiment 4 wherein the two or more BSR tables are different BSR tables for two or more different logical channels, LCHs, or logical channel groups, LCGs, for which respective buffer size values are to be reported in the BSR report.

Embodiment 6: The method of embodiment 4 or 5 wherein the two or more BSR tables are used to indicate buffer sizes for respective buffer size fields comprised in the BSR report.

Embodiment 7: The method of embodiment 6 wherein a size (e.g., number of bits) of one of the buffer size fields is different than a size of another one of the buffer size fields.

Embodiment 8: The method of any of embodiments 1 to 7 wherein selecting (604) the one or more BSR tables comprises selecting (604) the one or more BSR tables to be used for the BSR report from among the two or more available BSR tables based on BSR table mappings, BSR table mappings comprising: (i) mappings between the two or more available BSR tables and two or more services, (ii) mappings between the two or more available BSR tables and two or more LCHs, (iii) mappings between the two or more available BSR tables and two or more LCGs, (iv) mappings between the two or more available BSR tables and two or more numerologies, (v) mappings between the two or more available BSR tables and two or more bitrates, (vi) mappings between the two or more available BSR tables and two or more buffer levels, (vii) mappings between the two or more available BSR tables and two or more physical layer priorities, or (viii) a combination of any two or more of (i)-(vii).

Embodiment 9: The method of embodiment 8 further comprising obtaining (602) the BSR table mappings.

Embodiment 10: The method of any of embodiments 1 to 9 further comprising obtaining (600) information that defines the two or more available BSR tables.

Embodiment 11: The method of embodiment 10 wherein the information that defines the two or more available BSR tables comprises information that defines, for each available BSR table from among the two or more available BSR tables, a plurality of buffer size values in the available BSR table.

Embodiment 12: The method of embodiment 10 or 11 wherein the information that defines the two or more available BSR tables comprises information that defines, for each of at least one of the two or more available BSR tables, information that indicates a granularity of the available BSR table.

Embodiment 13: The method of any of embodiments 1 to 12 wherein selecting (604) the one or more BSR tables comprises selecting (604) the one or more BSR tables from among a set of BSR tables comprising the two or more available BSR tables and a default BSR table.

Embodiment 14: The method of any of embodiments 1 to 13 further comprising sending (610), to the base station 502, one or more indications of the one or more BSR tables used for the BSR report, respectively.

### Group B Embodiments

Embodiment 15: A method performed by a base station (502) for a cellular communications system (500), the method comprising: receiving (608) a buffer status reporting, BSR, report from a wireless communication device (512), the BSR report comprising one or more buffer size fields; and interpreting (612) one or more buffer size fields comprised in the BSR report based on one or more respective BSR tables used for the one or more buffer size fields.

Embodiment 16: The method of embodiment 15 wherein the one or more BSR tables are from among two or more available BSR tables, the two or more available BSR tables comprising two or more BSR tables defined based on a maximum uplink transport block size, a maximum number of MIMO layers, a maximum number of component carriers, a maximum carrier bandwidth of each component carrier that the wireless communication device (512) may support, a longest HARQ round-trip-time length, a fraction of slots that are uplink slots in case of TDD, and/or a number of bits occupied by a buffer size field of the BSR report.

Embodiment 17: The method of embodiment 15 or 16 wherein the one or more BSR tables used for the one or more buffer size fields comprised in the BSR report are a function of one or more parameters, the one or more parameters comprising: (a) one or more services associated with one or more logical channels, LCHs, or logical channel groups, LCGs, for which one or more respective buffer size values are reported in the BSR report, (b) the one or more LCHs or LCGs for which one or more respective buffer size values are reported in the BSR report, (c) one or more numerologies used for the one or more LCHs or LCGs for which one or more respective buffer size values are reported in the BSR report, (d) one or more bitrates used for the one or more LCHs or LCGs for which one or more respective buffer size values are reported in the BSR report, (e) one or more buffer levels associated with the one or more LCHs or LCGs for which one or more respective buffer size values are reported in the BSR report, (f) one or more physical layer priorities associated with the one or more LCHs or LCGs for which one or more respective buffer size values be reported in the BSR report, (g) one or more capabilities of the wireless communication device (512), (h) a channel condition for a radio channel between the wireless communication device (512) and the base station (502), (i) a system load of the cellular communications system (500), (j) a measured BSR mismatch, or (k) a combination of any two or more of (a)-(f);

Embodiment 18: The method of any of embodiments 16 to 18 wherein the one or more buffer size fields consist of two or more buffer size fields, and the one or more BSR tables consist of two or more BSR tables used for the two or more buffer size fields, respectively.

Embodiment 19: The method of embodiment 19 wherein the two or more BSR tables are different BSR tables for two or more different logical channels, LCHs, or logical channel groups, LCGs, for which respective buffer size values are reported in the BSR report.

Embodiment 20: The method of embodiment 19 or 20 wherein a size (e.g., number of bits) of one of the buffer size fields is different than a size of another one of the buffer size fields.

Embodiment 21: The method of any of embodiments 16 to 21 wherein the one or more BSR tables used for the one or more buffer size fields in the BSR report are a function of one or more BSR table mappings comprising: (i) mappings between the two or more available BSR tables and two or more services, (ii) mappings between the two or more available BSR tables and two or more LCHs, (iii) mappings between the two or more available BSR tables and two or more LCGs, (iv) mappings between the two or more available BSR tables and two or more numerologies, (v) mappings between the two or more available BSR tables and two or more bitrates, (vi) mappings between the two or more available BSR tables and two or more buffer levels, (vii) mappings between the two or more available BSR tables and two or more physical layer priorities, (viii) a combination of any two or more of (i)-(vii).

Embodiment 22: The method of embodiment 22 further comprising providing (602A) the BSR table mappings to the wireless communication device (512).

Embodiment 23: The method of any of embodiments 16 to 23 further comprising providing (600A), to the wireless communication device (512), information that defines the two or more available BSR tables.

Embodiment 24: The method of embodiment 24 wherein the information that defines the two or more available BSR tables comprises information that defines, for each available BSR table from among the two or more available BSR tables, a plurality of buffer size values in the available BSR table.

Embodiment 25: The method of embodiment 24 or 25 wherein the information that defines the two or more available BSR tables comprises information that defines, for each of at least one of the two or more available BSR tables, information that indicates a granularity of the available BSR table.

Embodiment 26: The method of any of embodiments 16 to 26 further comprising providing (604A) a default BSR table to the wireless communication device (512).

Embodiment 27: The method of any of embodiments 16 to 27 further comprising receiving (610), from the wireless communication device (512), one or more indications of the one or more BSR tables used for the BSR report, respectively.

Embodiment 28: The method of embodiment 28 wherein interpreting (612) the BSR report comprises interpreting (612) the one or more buffer size fields comprised in the BSR report based on the one or more respective BSR tables indicated by the wireless communication device (512).

### Group C Embodiments

Embodiment 29: A wireless communication device comprising: processing circuitry configured to perform any of the steps of any of the Group A embodiments; and power supply circuitry configured to supply power to the wireless communication device.

Embodiment 30: A base station comprising: processing circuitry configured to perform any of the steps of any of the Group B embodiments; and power supply circuitry configured to supply power to the base station.

Embodiment 31: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Those skilled in the art will recognize improvements and modifications to the embodiments of the present disclosure. All such improvements and modifications are considered within the scope of the concepts disclosed herein.

1. A method performed by a wireless communication device for sending a buffer status reporting, BSR, report in a cellular communications system, the method comprising:
selecting, based on one or more parameters, one or more BSR tables to be used for a BSR report from among two or more available BSR tables, wherein the one or more parameters comprise:
(a) one or more services associated with one or more logical channels, LCHs, or logical channel groups, LCGs, for which one or more respective buffer size values are to be reported in the BSR report;
(b) the one or more LCHs or LCGs for which one or more respective buffer size values are to be reported in the BSR report;
(c) one or more numerologies used for the one or more LCHs or LCGs for which one or more respective buffer size values are to be reported in the BSR report;
(d) one or more bitrates used for the one or more LCHs or LCGs for which one or more respective buffer size values are to be reported in the BSR report;
(e) one or more buffer levels associated with the one or more LCHs or LCGs for which one or more respective buffer size values are to be reported in the BSR report;
(f) one or more physical layer priorities associated with the one or more LCHs or LCGs for which one or more respective buffer size values are to be reported in the BSR report;
(g) one or more capabilities of the wireless communication device;
(h) a channel condition for a radio channel between the wireless communication device and the base station;
(i) a system load of the cellular communications system;
(j) a measured BSR mismatch;
(k) one or more respective services; or
(l) a combination of any two or more of (a)-(k);
generating the BSR report using the one or more BSR tables; and
sending the BSR report to a base station.

2. The method of claim 1 wherein the two or more available BSR tables comprise two or more BSR tables defined based on (A) a maximum uplink transport block size, (B) a maximum number of Multiple Input Multiple Output, MIMO, layers, (C) a maximum number of component carriers, (D) a maximum carrier bandwidth of each component carrier that the wireless communication device may support, (E) a longest Hybrid Automatic Repeat Request, HARQ, round-trip-time length, (F) a fraction of slots that are uplink slots in case of Time Division Duplexing, TDD, (G) a number of bits occupied by a buffer size field of the BSR report, or (H) any combination of two or more of (A)-(G).

3. The method of claim 1 wherein selecting the one or more BSR tables comprises selecting, based on the one or more parameters, two or more BSR tables from among the two or more available BSR tables.

4. The method of claim 3 wherein the two or more BSR tables are different BSR tables for two or more different logical channels, LCHs, or logical channel groups, LCGs, for which respective buffer size values are to be reported in the BSR report.

5. The method of claim 3 wherein the two or more BSR tables are used to indicate buffer sizes for respective buffer size fields comprised in the BSR report.

6. The method of claim 5 wherein a size of one of the buffer size fields is different than a size of another one of the buffer size fields.

7. The method of claim 1 wherein selecting the one or more BSR tables comprises selecting the one or more BSR tables to be used for the BSR report from among the two or more available BSR tables based on BSR table mappings, BSR table mappings comprising:
(i) mappings between the two or more available BSR tables and two or more services;
(ii) mappings between the two or more available BSR tables and two or more LCHs;
(iii) mappings between the two or more available BSR tables and two or more LCGs;
(iv) mappings between the two or more available BSR tables and two or more numerologies;
(v) mappings between the two or more available BSR tables and two or more bitrates;
(vi) mappings between the two or more available BSR tables and two or more buffer levels;
(vii) mappings between the two or more available BSR tables and two or more physical layer priorities; or
(viii) a combination of any two or more of (i)-(vii).

8. The method of claim 7 further comprising obtaining the BSR table mappings.

9. The method of claim 1 further comprising obtaining information that defines the two or more available BSR tables.

10. The method of claim 9 wherein the information that defines the two or more available BSR tables comprises information that defines, for each available BSR table from among the two or more available BSR tables, a plurality of buffer size values in the available BSR table.

11. The method of claim 9 wherein the information that defines the two or more available BSR tables comprises information that defines, for each of at least one of the two or more available BSR tables, information that indicates a granularity of the available BSR table.

12. The method of claim 1 wherein selecting the one or more BSR tables comprises selecting the one or more BSR tables from among a set of BSR tables comprising the two or more available BSR tables and a default BSR table.

13. The method of claim 1 further comprising sending, to the base station, one or more indications of the one or more BSR tables used for the BSR report, respectively.

14. (canceled)

15. (canceled)

16. A wireless communication device for sending a buffer status reporting, BSR, report in a cellular communications system, the wireless communication device comprising:
one or more transmitters;
one or more receivers; and
processing circuitry associated with the one or more transmitters and the one or more receivers, the processing circuitry configured to cause the wireless communication device to:
select, based on one or more parameters, one or more BSR tables to be used for a BSR report from among two or more available BSR tables, wherein the one or more parameters comprise:
(a) one or more services associated with one or more logical channels, LCHs, or logical channel groups, LCGs, for which one or more respective buffer size values are to be reported in the BSR report;
(b) the one or more LCHs or LCGs for which one or more respective buffer size values are to be reported in the BSR report;
(c) one or more numerologies used for the one or more LCHs or LCGs for which one or more respective buffer size values are to be reported in the BSR report;
(d) one or more bitrates used for the one or more LCHs or LCGs for which one or more respective buffer size values are to be reported in the BSR report;
(e) one or more buffer levels associated with the one or more LCHs or LCGs for which one or more respective buffer size values are to be reported in the BSR report;
(f) one or more physical layer priorities associated with the one or more LCHs or LCGs for which one or more respective buffer size values are to be reported in the BSR report;
(g) one or more capabilities of the wireless communication device;
(h) a channel condition for a radio channel between the wireless communication device and the base station;
(i) a system load of the cellular communications system;
(j) a measured BSR mismatch;
(k) one or more respective services; or
(l) a combination of any two or more of (a)-(k);
generate the BSR report using the one or more BSR tables; and
send the BSR report to a base station.

17-34. (canceled)
